(19) United States
(12) Patent Application Publication
(10) Pub. No.: US 2026/0124870 A1
(43) Pub. Date: May 7, 2026

(54) SPRING SYSTEM HAVING A SPRING ARRANGEMENT

(71) Applicant: Ford Global Technologies, LLC, Dearborn, MI (US)

(72) Inventors: Thomas GERHARDS, Niederzier (DE); Roger GRAAF, Vaals (NL); Ralf HINTZEN, Aachen (DE); Paul ZANDBERGEN, Wurselen (DE); Rainer SOUSCHEK, Aachen (DE)

(21) Appl. No.: 19/379,105

(22) Filed: Nov. 4, 2025

(30) Foreign Application Priority Data
Nov. 4, 2024 (DE) 102024131988.7

(51) Int. Cl. B60G 17/02; B60G 11/18; B60G 17/015

(52) U.S. Cl. CPC B60G 17/025; B60G 11/183; B60G 11/184; B60G 17/0157; B60G 2202/134; B60G 2202/42; B60G 2204/62; B60G 2206/42; B60G 2206/70; B60G 2500/20; B60G 2600/182; B60G 2800/162; B60G 2800/916

(57) ABSTRACT

A spring arrangement for suspending a wheel suspension element relative to a vehicle body includes a spring element extending along a torsion axis and having a multiplicity of torsion portions arranged one around another in radial succession. Adjacent torsion portions are predominantly separate from one another in each case, but connected in a rotationally fixed manner in certain regions by a connecting portion. An innermost torsion portion and an outermost torsion portion each have an attachment region and one attachment region is connected to the vehicle body and the other attachment region is connected to the wheel suspension element. A controllable actuator may act on different torsion portions of the spring element relative to the vehicle body and to set the characteristics of the spring arrangement.

### TECHNICAL FIELD

Example embodiments generally relate to a spring system having a spring arrangement for suspending a wheel suspension element relative to a vehicle body and means for actuating the spring arrangement.

### BACKGROUND

A spring arrangement for suspending a wheel suspension element relative to a vehicle body is known from DE 10 2020 213 644 B4. The spring arrangement has a spring element extending along a torsion axis and having a multiplicity of torsion portions arranged one around another in radial succession, wherein adjacent torsion portions are predominantly separate from one another in each case, but connected in a rotationally fixed manner in certain regions by a connecting portion, wherein an innermost torsion portion and an outermost torsion portion each have an attachment region and one attachment region is connected to the vehicle body and the other attachment region is connected to the wheel suspension element. As means for actuating the spring arrangement, a multiplicity of independently adjustable locking elements are provided, via which different torsion portions of the spring element may be optionally locked or released relative to the vehicle body.

This known spring arrangement has a compact design and makes good use of the available installation space. However, it is disadvantageous in that the multiplicity of independently adjustable locking elements is linked to an increase in the component diversity and in the installation effort. Moreover, a custom characteristic curve of the spring element cannot be set via the locking elements since these only enable the different torsion portions of the spring element to be locked or released relative to the vehicle body.

U.S. Pat. No. 8,827,287 B2 describes an axle control element of a motor vehicle, having a torsion spring system as an accumulator spring, which, on the one hand, is connected to a wheel guide element via a rotary arm and, on the other, is supported on the vehicle body in a fixed manner via a controllable actuator, wherein the torsion spring system has, nested one inside another, at least one torsion tube and at least one torsion bar, wherein the actuator consists of a servomotor unit, which is spaced apart from the torsion spring system and is fixed to the vehicle body, and a pivotally controllable drive lever, which is connected to said servomotor unit, and the drive lever is connected to a torsion tube and an output lever is connected to a torsion bar and is also connected to the wheel guide element, either directly or indirectly via a coupling, or, correspondingly, the drive lever is connected to a torsion bar and the output lever is connected to a torsion tube and is also connected to the wheel guide element, either directly or indirectly via a coupling.

This known arrangement is disadvantageous in that a very large installation space is needed since, on the one hand, the torsion spring system is connected to the wheel guide element via the rotary arm and, on the other, the servomotor unit is spaced apart from the torsion spring system via the drive lever. In structural terms, this arrangement also has a high component diversity owing to the lever used and is likewise difficult to install.

In view of this, the demonstrated prior art in the field of spring arrangements for suspending a wheel suspension element relative to a vehicle body still has room for improvements.

### BRIEF SUMMARY OF SOME EXAMPLES

The disclosure relates to demonstrating an improved spring effect acting on the vehicle body, whilst maintaining a compact design of the spring arrangement.

According to an example embodiment, the object is achieved by a spring system having a spring arrangement for suspending a wheel suspension element relative to a vehicle body and means for actuating the spring arrangement.

A spring system is demonstrated, which has a spring arrangement for suspending a wheel suspension element relative to a vehicle body and means for actuating the spring arrangement, wherein the spring arrangement has a spring element extending along a torsion axis and having a multiplicity of torsion portions arranged one around another in radial succession, wherein adjacent torsion portions are predominantly separate from one another in each case, but connected in a rotationally fixed manner in certain regions by a connecting portion, wherein an innermost torsion portion and an outermost torsion portion each have an attachment region and one attachment region is connected to the vehicle body and the other attachment region is connected to the wheel suspension element. According to the invention, a controllable actuator is designed to act on different torsion portions of the spring element relative to the vehicle body and to set the characteristic of the spring arrangement.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a basic construction of a spring arrangement according to an example embodiment;

FIG. 2 shows a spring system with an electrorheological fluid according to an example embodiment;

FIG. 3 shows a spring system with an electrorheological fluid according to an example embodiment;

FIG. 4 shows a spring system with a latching element according to an example embodiment;

FIG. 5 shows a spring system with a latching element according to an example embodiment;

FIG. 6 shows a spring system with a friction coupling according to an example embodiment;

FIG. 7 shows a spring system with a friction coupling according to an example embodiment; and

FIG. 8 shows a spring system with a belt drive assembly according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. It should be noted that the features and measures presented individually in the following description can be combined in any technically feasible manner, giving rise to further embodiments of the invention. The description additionally characterizes and specifies aspects of some example embodiments, particularly in conjunction with the figures. It should be noted that the features and measures mentioned individually in the following description can be combined with one another in any technically expedient manner and reveal further embodiments of the invention. The description additionally characterizes and specifies the invention in particular in conjunction with the figures. The terms “first”, “second”, etc. used in this description serve merely for the purpose of distinction. In particular, the use of these terms is not to imply any order or priority of the elements or objects mentioned in connection therewith.

Some example embodiments may provide that the spring characteristic of the spring arrangement may be custom set via the controllable actuator, subject to requirements. These requirements come from a control unit, in which, for example, vehicle and/or environmental parameters of the vehicle and/or custom setpoint value requirements (for setting a hard or soft chassis of the vehicle, for example) are taken into account. On the one hand, it is conceivable that the limit regions of the characteristic curve of the spring arrangement (locking or release of the different torsion portions of the spring element) and, in addition, the regions of the characteristic curve in between can be continuously changed via the controllable actuator. On the other hand, it is conceivable for only the regions of the characteristic curve of the spring arrangement that lie between the two limit regions to be continuously changed or set via the controllable actuator. The use of such a controllable actuator according to the invention enables a reduction in the component diversity whilst maintaining the compact design since there is no need to use and install levers.

According to an example embodiment, it is provided that the actuator is arranged adjacent to the spring arrangement and is designed to generate an electric field, wherein, within the spring arrangement, at least one chamber, formed by torsion portions of the spring element, or other chambers, sealed by closure plates, between torsion tubes lying one inside another is or are filled with an electrorheological fluid on which the electric field acts. Alternatively, the at least one chamber may be filled with a magnetorheological fluid, on which a magnetic field acts, which magnetic field is generated by an actuator designed for this purpose. An electrorheological fluid is also conceivable since a viscous change is implemented, which increases or decreases the damping or friction between the torsion tubes in order to couple or uncouple these torsion tubes and thereby influence the overall spring stiffness, as additionally described below.

Levers or the like for inducing the actuator to act on the spring arrangement are not required, since it is sufficient to connect the actuator to a control unit via a cable connection. The compact design is maintained in that the actuator is arranged adjacent to the spring arrangement. It is even conceivable for the actuator to be formed together with the spring arrangement as a structural unit which may be installed in one step. Subject to the requirements for the spring characteristic, the controllable actuator generates an electric or magnetic field which acts on an electrorheological or magnetorheological fluid, which is located in at least one chamber of the spring arrangement. The at least one chamber is formed by torsion portions of the spring element and is sealed after receiving the electrorheological or magnetorheological fluid, so that this fluid remains therein during the operation of the spring arrangement. Through appropriate activation of the actuator, this changes its electric or magnetic field which acts on the electrorheological or magnetorheological fluid, resulting in a soft or harder spring characteristic. As a result, the spring characteristic may be custom set between the limit regions (locking or release of the different torsion portions of the spring element relative to the vehicle body). This mode of operation is advantageously completely or mostly wear-free, resulting in an increased durability of the spring system.

In a corresponding configuration, it is provided that precisely two chambers, formed by torsion portions of the spring element, are filled with the electrorheological or magnetorheological fluid on which the electric or magnetic field acts. Above all, this enables the stiffness of the spring arrangement (harder or more rigid chassis) to be significantly increased when the actuator is activated accordingly.

As an alternative to filling two chambers with the electrorheological or magnetorheological fluid, it is conceivable for precisely two chambers or more than two chambers to be formed by torsion portions of the spring element and for only one of the two chambers to be filled with the electrorheological or magnetorheological fluid on which the electric or magnetic field acts.

Torsion tubes of the same length and same wall thickness, but with different diameters, generate different spring rates. If the inner, preferably narrower tubes are coupled to one another via the fluid which changes in viscosity, the change in the spring rate (at least in the higher frequency excitation spectrum) is different to the change that occurs when the outer, preferably larger tubes are coupled.

In detail, a fixed (rigid) coupling, which merely influences the spring rate but brings about a damping which is preferably desired in respect of an adaptive active chassis of a vehicle, is not realized with a higher viscosity. The condition for filling a specific chamber is therefore based on the desired overall spring characteristic curve or damping change which is to be generated.

According to another example embodiment, it is provided that at least one of the torsion portions of the spring element is connected to a latching element and the latching element is connected to the actuator. The controllable actuator is connected to the spring arrangement, or separated therefrom, via the latching element. Therefore, to custom change the spring characteristic of the spring arrangement, the actuator is connected to the spring arrangement via the latching element. To set the spring characteristic exhibited by the spring arrangement when it is not acted upon by the actuator, the latching connection between the actuator and the spring arrangement is removed.

According to another example embodiment, it is provided that the actuator is connected to the innermost torsion portion via the latching element. Alternatively, it may be provided that the actuator is connected to a torsion portion surrounding the innermost torsion portion, and/or to at least a further torsion portion surrounding the innermost torsion portion, via the latching element. A combination is also conceivable, in which the actuator is connected to the innermost torsion portion, and to the torsion portion surrounding the innermost torsion portion, via the latching element. Depending on the chosen option, it is possible to specify a spring characteristic which is peculiar to the spring arrangement and which may be custom changed, and therefore custom set, by switching on the actuator This also applies to the connections between the actuators, which are described below, and the spring arrangement.

In an example embodiment, it is provided that at least one of the torsion portions of the spring element is connected to the actuator via a friction coupling. The controllable actuator is connected to the spring arrangement, or separated therefrom, via the friction coupling. Therefore, to custom change the spring characteristic of the spring arrangement, the actuator is connected to the spring arrangement via the friction coupling. To set the spring characteristic exhibited by the spring arrangement when it is not acted upon by the actuator, the frictional connection between the actuator and the spring arrangement is removed.

The friction coupling acts on the inner torsion tubes in a specific manner and connects some of the interlocking tubes to one another in order to thus change the operative length of the torsion spring and therefore, in a specific manner, the spring rate. Complete coupling or uncoupling may be considered for purely changing the spring rate. In contrast, a continuous change in the friction corresponds to the previously described viscous coupling via rheological fluids (damping change).

According to another example embodiment, it is provided that at least one of the torsion portions of the spring element is connected to the actuator via a belt drive. The spring characteristic of the spring arrangement is custom changed by the controllable actuator via the belt drive, in that the torsion portions on which the belt drive acts are subject to torsion (twisting) relative to the other torsion portions. To set the spring characteristic exhibited by the spring arrangement when it is not acted upon by the actuator, the belt drive is brought into a corresponding normal position or the connection between the actuator and the spring arrangement is removed.

According to another example embodiment, it is provided that at least one of the torsion portions has a closure in an end region, wherein the torsion portion and the closure are formed in one piece. A particular torsion portion in the spring arrangement has a tubular form, wherein this torsion portion comprises the closure in its at least one end region for strengthening purposes and this structure is formed in one piece. The closure serves to strengthen this end region, which is particularly advantageous if the actuator is connected to this torsion portion via the latching connection or the frictional connection or the belt drive, for example.

Common to all of the variants described above is that the compact design of the spring arrangement is maintained and is advantageously enhanced in that the controllable actuator is arranged adjacent to—i.e. in the immediate vicinity of—the spring arrangement.

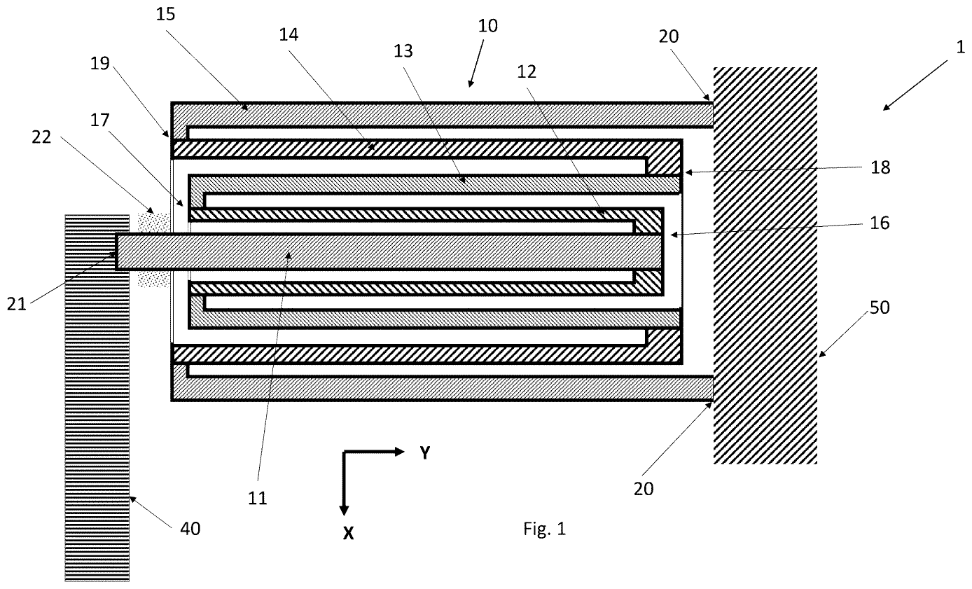

FIG. 1 shows a construction of a spring arrangement 1. A schematic section of the spring arrangement 1 of a motor vehicle, for example an automobile or truck, is shown. A trailing arm 40 extending along the X axis of the motor vehicle is mounted on a vehicle body 50 via a spring element 10. A wheel carrier (not illustrated here), which is designed to be substantially rigid and on which a vehicle wheel is, in turn, rotatably mounted, is arranged on the trailing arm 40. The spring element 10 is formed symmetrically to a torsion axis and has a substantially cylindrical form (also referred to as a tubular form). By way of example, the torsion axis is aligned parallel to the Y axis of the motor vehicle. A first torsion portion 11 arranged radially innermost with respect to the torsion axis has a cylindrical, closed form. A wheel-side attachment region 21 is formed on the first torsion portion 11 and is connected to the trailing arm 40, for example via material bonding and/or positive mechanical engagement. A second torsion portion 12, which has a tubular form and surrounds the first torsion portion 11, follows the first torsion portion 11 radially externally. It is predominantly spaced apart from the first torsion portion 11, although it is connected to the first torsion portion 11 via a first connecting portion 16 at an end opposite the wheel-side attachment region 21. In the exemplary embodiment shown here, the radially extending first connecting portion 16 is formed in one piece with the second torsion portion 12, whilst the first torsion portion 11 has been prefabricated separately and then connected to the first connecting portion 16 in a rotationally fixed manner, for example via material bonding. This configuration may be used, for example, if the spring element 10 is composed of individual components made of spring steel, which are prefabricated and then connected, for example, via a material bond. However, the first connecting portion 16 may also be prefabricated separately from both torsion portions 11, 12 or it may be formed with both torsion portions 11, 12. A third torsion portion 13 is connected to the second torsion portion 12 via a second connecting portion 17. A fourth torsion portion 14 is connected to the third torsion portion 13 via a third connecting portion 18. A fifth torsion portion 15 is connected to the fourth torsion portion 14 via a fourth connecting portion 19. The connecting portions 16-19 are arranged in an alternating manner at the end of the torsion portions 11-15 with respect to the axial direction. This means that the first connecting portion 16 is arranged at an end remote from the wheel, the second connecting portion 17 is arranged at an end on the wheel side, the third connecting portion 18 is in turn arranged at an end remote from the wheel and the fourth connecting portion 19 is in turn arranged at an end on the wheel side. This gives a meandering structure of the spring element 10 in cross section. A vehicle-side attachment region 20 is formed on the fifth torsion portion 15 and is connected to the vehicle body 50, for example via positive mechanical engagement and/or material bonding. Whilst the fifth, and therefore outermost, torsion portion 15 is connected to the vehicle body 50 in a rotationally fixed manner on one side, the first torsion portion 11 is mounted on the vehicle body 50 via a pivot bearing 22, so that it is rotatable about the torsion axis. The spring element 10 according to the exemplary embodiment according to FIG. 1 has, by way of example, five torsion portions 11-15. This is not restrictive either for this exemplary embodiment or in general. Rather, the number of torsion options can be adapted to the desired specifications. If a force acts on the vehicle wheel in driving mode, this results in a torque in the trailing arm 40, which in turn acts on the spring element 10 as a torsional moment. Since the torsional moment acts on all torsion portions 11-15, these are each subject to torsion, wherein the individual deformations of the torsion portions 11-15 are added together so that the spring element 10 reacts in an, on the whole, substantially more torsionally flexible manner than each of the torsion portions 11-15 alone. Owing to the nested structure of the spring element 10, this advantageously has a comparatively small length along the torsion axis so that it is very compact and takes up little space. This design forms the basis of the following variants with actuators which can be controlled differently.

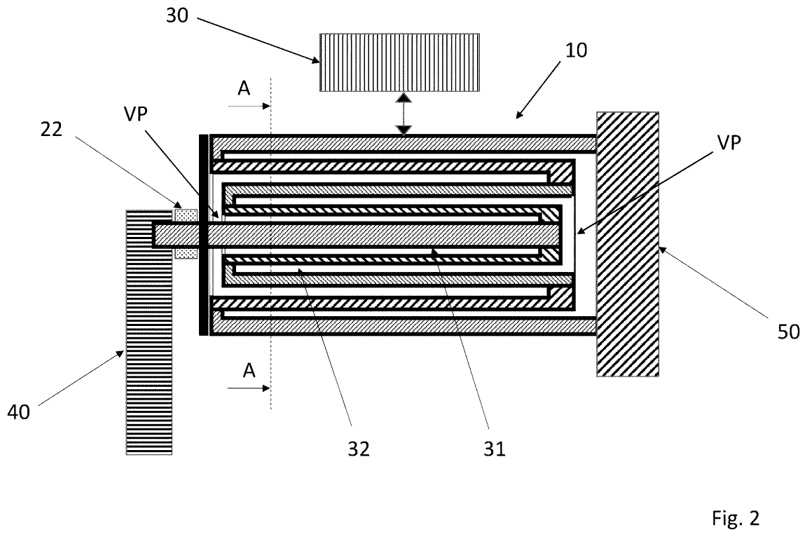

FIG. 2 shows an exemplary embodiment of a spring system with the spring element 10 according to FIG. 1. An actuator 30 is adjacently associated with the spring element 10 and generates a controllable electric field for setting the spring characteristic of the spring element 10. This electric field acts on an electrorheological fluid, with which at least one chamber 31, 32 or the chambers 31 and 32 (or further clearances between torsion tubes located further outwards, which, in this case, likewise also have to be made fluid-tight using closure plates) is or are permanently filled. It goes without saying that, within the context of the invention, more than one chamber 31, 32, e.g. two chambers or more, can be permanently filled with the fluid. The at least one chamber 31 is formed by the torsion portions 11, 12 and the associated connecting portion. Moreover, a closure plate VP is provided in the end region of the spring element 10, toward the vehicle suspension arm 40. After this chamber 31 has been filled with fluid, it is permanently sealed, for example via the closure plate VP. The same applies to the further chamber 32, that of the torsion portions 12, 13 and a corresponding closure plate toward the vehicle body 50 in the end region of the spring element 10. Via the combination of filled chambers (31, 32 or both), it is possible to achieve different spring rates/damping changes in order to bring the overall spring rate/damping as close as possible to the desired characteristic curve.

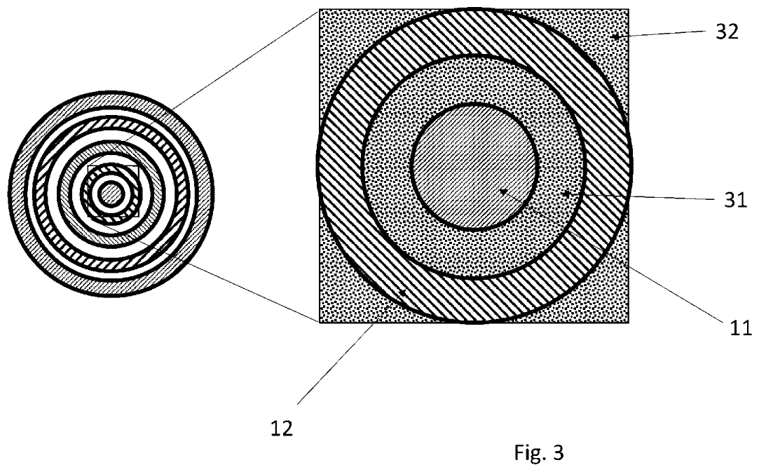

FIG. 3 shows a section A—A of FIG. 2 through the spring element 10 (illustration on the left) and an enlargement of this section (detail in the illustration on the right). It can be seen that the chambers 31, 32 which may be filled with an electrorheological fluid are formed by the torsion portions 11, 12 (and 13, not illustrated in FIG. 3). Depending on the setting of the desired characteristic curve, it is possible for only the one chamber 31 or only the other chamber 32 to be filled with the electrorheological fluid. However, it is also conceivable for both chambers 31, 32 to be filled with this fluid. It is likewise conceivable for more than two chambers to be formed by the torsion portions of the spring element 10, sealed by corresponding closure plates and filled with the corresponding fluids.

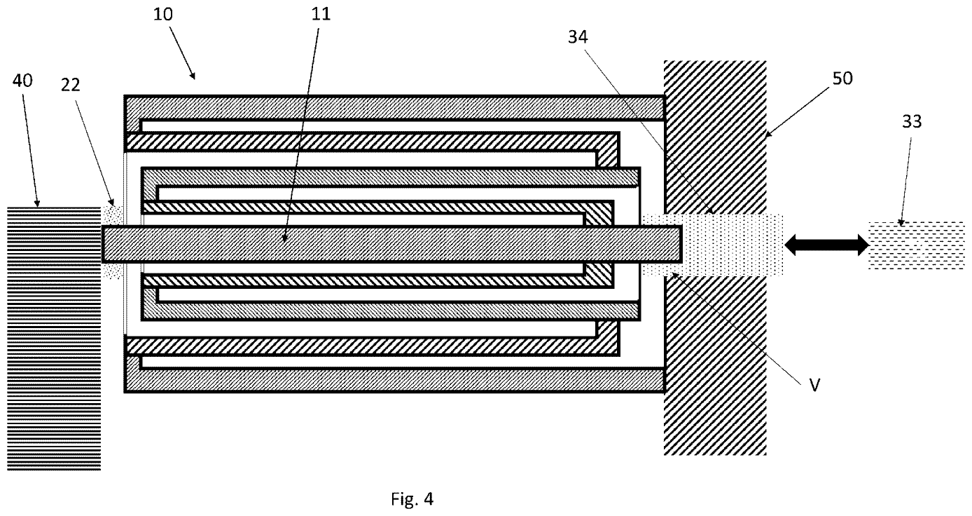

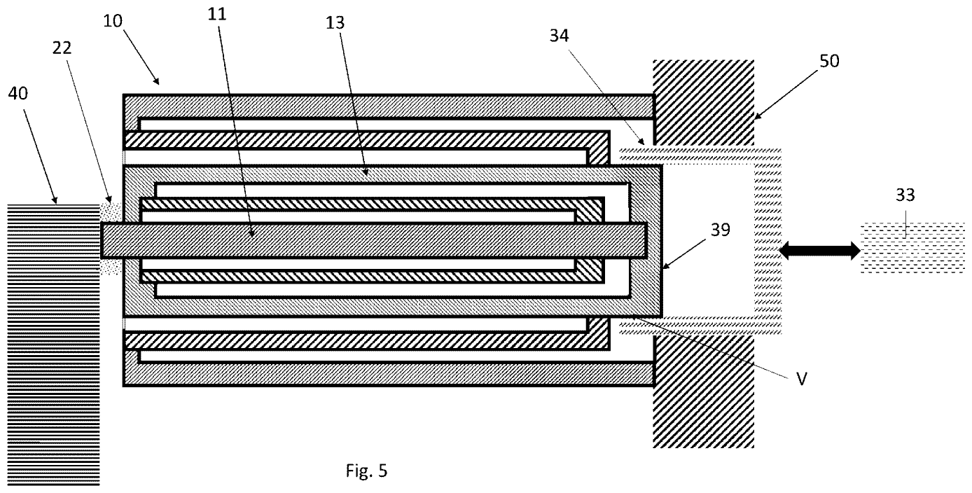

FIGS. 4 and 5 show a spring system with a latching connection. The controllable actuator 33 shown therein is connected to the spring element 10 via a latching element 34. The latching element 34 is connected to the actuator 33 and is actuated thereby. Therefore, a corresponding region of the spring element 10 may be coupled to or uncoupled from the actuator 33 in the manner of a latching coupling via the latching element 34.

In the example embodiment according to FIG. 4, the latching element 34 may be brought into operative connection with the torsion portion 11 through actuation via the actuator 33. After this has taken place, the actuator 33 may be controlled as required and the spring characteristic of the spring element 10 may therefore be set. As illustrated here, the spring is now in its most rigid position, since only the torsion portion 11 is still active and all further torsion elements are shorted.

According to the example embodiment according to FIG. 5, the latching element 34 can be brought into engagement with the end region of the torsion portion 13 which faces toward the vehicle body 50. Furthermore, it is shown that this end region is strengthened by a closure 39. Moreover, it is shown that the torsion portion 13 and the central torsion portion 11 are connected to one another via this closure 19, so that the controllable actuator 33 acts on the two torsion portions 11, 13 via the latching element 34. This action is not restricted to the two torsion portions 11, 13, but may also be applied to other torsion portions, and possibly to more than two torsion portions.

The latching element 34, as shown in different embodiments in FIGS. 4 and 5, and the associated torsion portion to be coupled is formed in the manner of a latching coupling, for example as a circumferential tongue and groove system or the like. The latching connection between the latching element 34 and its associated torsion portion of the spring element 10 takes place in a connecting region V.

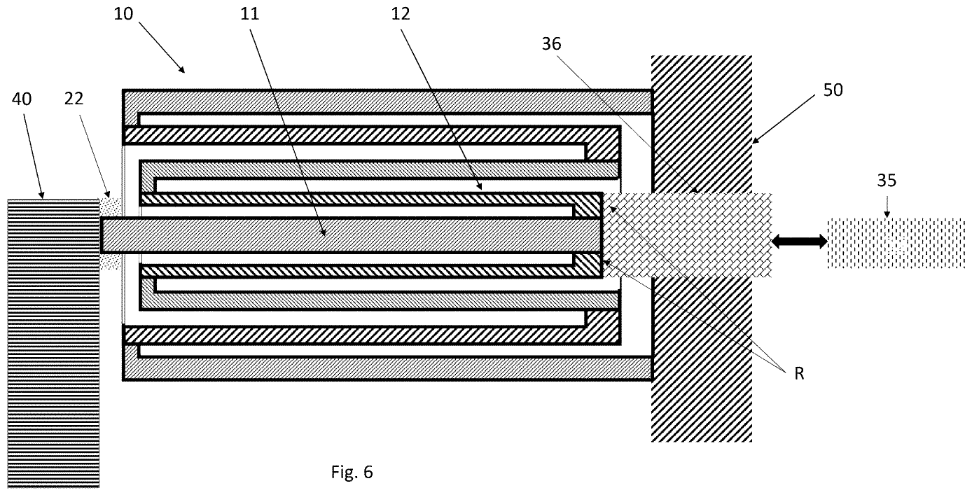

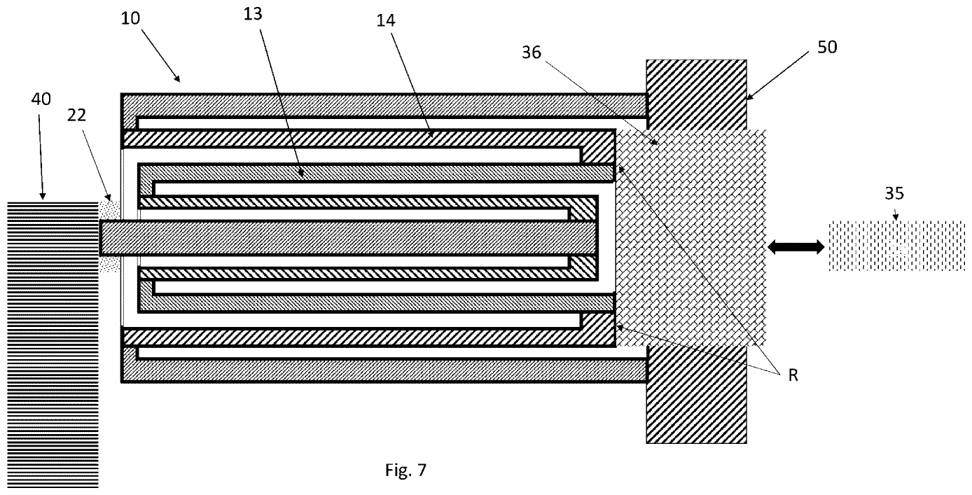

FIGS. 6 and 7 show a spring system with a friction coupling. The actuator 35 according to FIG. 6 is coupled to or uncoupled from the end region of the torsion portions 11, 12 which faces toward the vehicle body 50 via a friction coupling 36 (the coupled state being shown in the figure). After coupling has taken place via the friction coupling 36 in connecting region R, the actuator 35 may set the spring characteristic of the spring element 10 subject to requirements. FIG. 7 shows that the end regions of the torsion portions 13, 14 which face toward the vehicle body 50 are connected to the coupling 36 in connecting region R.

With regard to the configuration of the friction coupling 36 in connecting region R, a possible consideration is to couple or uncouple other and/or further regions of torsion portions of the spring element 10 to the friction coupling 36 so that, in the coupled state, the actuator 35 may act on the spring element 10 in a controlled manner for the purpose of setting the spring characteristic thereof.

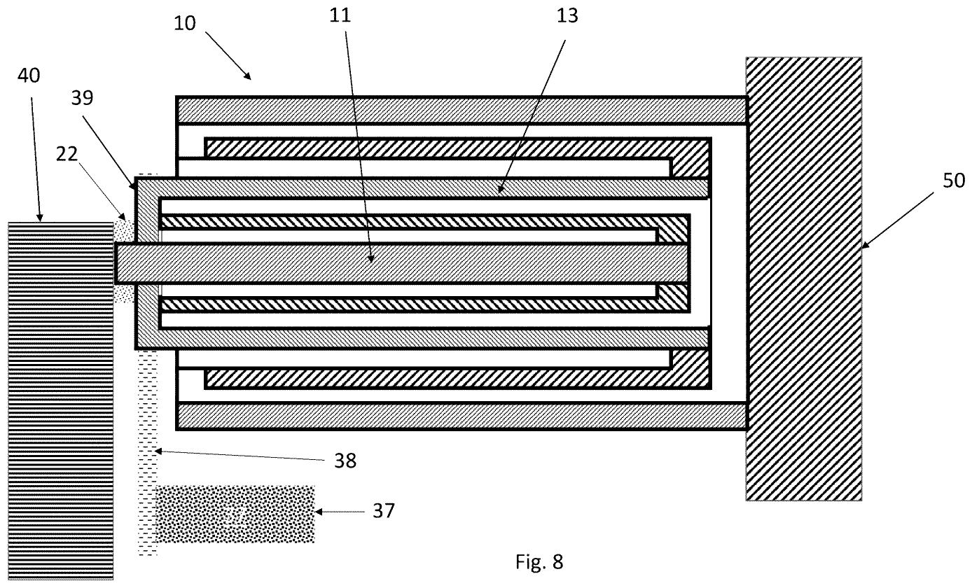

Finally, FIG. 8 shows a spring system with a belt drive. In this configuration, the actuator 37 is connected to the end regions of the torsion portions 11 which face toward the vehicle suspension arm 40 via a belt drive 38. To increase the operational reliability and the durability, a closure 39 is likewise present in this end region for strengthening purposes. As illustrated in FIG. 8, this end closure 39 may be connected to the torsion portion 11 or it may alternatively be uncoupled therefrom. Likewise, as already mentioned with regard to the latching connection or the friction coupling, torsion portions 11, 13 other than and/or further to the two shown in FIG. 8 may also cooperate with the belt drive 38.

In FIGS. 1 and 2 and 4 to 8, the bearing 22 is shown in the left end region of the torsion portion 11. It has the function of introducing the torques from a wheel carrier, in particular the trailing arm 40, into the spring system 10, preferably into the torsion element 11 of the spring system 10. Translatory forces from the wheel carrier should not influence the desired performance, strength and durability of the spring system 10 and are therefore not transmitted.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A spring system comprising:
a spring arrangement for suspending a wheel suspension element relative to a vehicle body; and
means for actuating the spring arrangement,
wherein the spring arrangement includes a spring element extending along a torsion axis and having a multiplicity of torsion portions arranged one around another in radial succession,
wherein adjacent torsion portions are predominantly separate from one another in each case, but connected in a rotationally fixed manner in certain regions by a connecting portion,
wherein an innermost torsion portion and an outermost torsion portion each have an attachment region and one attachment region is connected to the vehicle body and the other attachment region is connected to the wheel suspension element, and
wherein a controllable actuator acts on different torsion portions of the spring element relative to the vehicle body and sets a characteristic of the spring arrangement.

2. The spring system of claim 1, wherein the actuator is arranged adjacent to the spring arrangement and is designed to generate an electric or magnetic field,
wherein, within the spring arrangement, at least one chamber sealed by closure plates, between torsion tubes lying one inside and another and formed by torsion portions of the spring element is filled with an electrorheological or magnetorheological fluid on which the electric or magnetic field acts.

3. The spring system of claim 2, wherein the at least one chamber comprises two chambers and the two chambers are formed by torsion portions of the spring element and are filled with the electrorheological or magnetorheological fluid on which the electric or magnetic field acts.

4. The spring system of claim 2, wherein the at least one chamber comprises two chambers and only one of the two chambers is formed by torsion portions of the spring element and filled with the electrorheological or magnetorheological fluid on which the electric or magnetic field acts.

5. The spring system of claim 1, wherein at least one of the torsion portions of the spring element is connected to a latching element and the latching element is connected to the actuator.

6. The spring system of claim 5, wherein the actuator is connected to the innermost torsion portion via the latching element.

7. The spring system of claim 5, wherein the actuator is connected to a torsion portion surrounding the innermost torsion portion, and to at least a further torsion portion surrounding the innermost torsion portion, via the latching element.

8. The spring system of claim 5, wherein the actuator is connected to the innermost torsion portion, and to the torsion portion surrounding the innermost torsion portion, via the latching element.

9. The spring system of claim 1, wherein at least one of the torsion portions of the spring element is connected to the actuator via a friction coupling.

10. The spring system of claim 1, wherein at least one of the torsion portions of the spring element is connected to the actuator via a belt drive.
